(19) United States
(12) Patent Application Publication
(10) Pub. No.: US 2013/0301649 A1
(43) Pub. Date: Nov. 14, 2013

(54) CSMA/CA for Channels in Power Line Communication (PLC) Networks

(71) Applicant: TEXAS INSTRUMENTS INCORPORATED, Dallas, TX (US)

(72) Inventors: Kumaran Vijayasankar, Dallas, TX (US); Ramanuja Vedantham, Allen, TX (US); Tarkesh Pande, Dallas, TX (US)

(73) Assignee: Texas Instruments Incorporated, Dallas, TX (US)

(21) Appl. No.: 13/889,878

(22) Filed: May 8, 2013

Related U.S. Application Data
(60) Provisional application No. 61/644,597, filed on May 9, 2012.

(51) Int. Cl. H04L 12/413

(52) U.S. Cl. CPC H04L 12/413
USPC 370/445

(57) ABSTRACT

Embodiments of methods and systems for Carrier Sense Multiple Access with Collision Avoidance (CSMA/CA) with a random backoff time on a Power Line Communication (PLC) network are disclosed. The CSMA/CA method is independent of the algorithm used to update a contention window, so any contention window algorithm is supported. The PLC node runs an energy detection process first and then uses preamble detection only after energy detection is positive, or the node may run both energy detection and preamble detection simultaneously. Upon detection of a possible transmission on a PLC line due to energy detection, the PLC node will freeze a backoff counter decrementing process and will then wait for preamble detection to complete. If no energy is detected on the line, or if no preamble is detected after energy is sensed on the line, then the node will transmit is allowed by the contention window value.

### CROSS-REFERENCE TO RELATED APPLICATIONS

This application claims the benefit of the filing date of U.S. Provisional Patent Application No. 61/644,597, which is titled “CSMA/CA for Power line communication channels (PLC)” and was filed on May 9, 2012, the disclosure of which is hereby incorporated by reference herein in its entirety.

### BACKGROUND

Power line communications (PLC) include systems for communicating data over the same medium that is also used to transmit electric power to residences, buildings, and other premises, such as wires, power lines, or other conductors. In its simplest terms, PLC modulates communication signals over existing power lines. This enables devices to be networked without introducing any new wires or cables. This capability is extremely attractive across a diverse range of applications that can leverage greater intelligence and efficiency through networking. PLC applications include utility meters, home area networks, and appliance and lighting control.

PLC is a generic term for any technology that uses power lines as a communications channel. Various PLC standardization efforts are currently in work around the world. The different standards focus on different performance factors and issues relating to particular applications and operating environments. Two of the most well-known PLC standards are G3 and PRIME. G3 has been approved by the International Telecommunication Union (ITU). IEEE is developing the IEEE P1901.2 standard that is based on G3. Each PLC standard has its own unique characteristics.

Using PLC to communicate with utility meters enables applications such as Automated Meter Reading (AMR) and Automated Meter Infrastructure (AMI) communications without the need to install additional wires. Consumers may also use PLC to connect home electric meters to an energy monitoring device or in-home display monitor their energy consumption and to leverage lower-cost electric pricing based on time-of-day demand.

As the home area network expands to include controlling home appliances for more efficient consumption of energy, OEMs may use PLC to link these devices and the home network. PLC may also support home and industrial automation by integrating intelligence into a wide variety of lighting products to enable functionality such as remote control of lighting, automated activation and deactivation of lights, monitoring of usage to accurately calculate energy costs, and connectivity to the grid.

The manner in which PLC systems are implemented depends upon local regulations, characteristics of local power grids, etc. The frequency band available for PLC users depends upon the location of the system. In Europe, PLC bands are defined by the CENELEC (European Committee for Electrotechnical Standardization). The CENELEC-A band (3 kHz-95 kHz) is exclusively for energy providers. The CENELEC-B, C, D bands are open for end user applications, which may include PLC users. Typically, PLC systems operate between 35-90 kHz in the CENELEC A band using 36 tones spaced 1.5675 kHz apart. In the United States, the FCC has conducted emissions requirements that start at 535 kHz and therefore the PLC systems have an FCC band defined from 154-487.5 kHz using 72 tones spaced at 4.6875 kHz apart. In other parts of the world different frequency bands are used, such as the Association of Radio Industries and Businesses (ARIB)-defined band in Japan, which operates at 10-450 kHz, and the Electric Power Research Institute (EPRI)-defined bands in China, which operates at 3-90 kHz.

In PLC networks, channel access may be accomplished using Carrier Sense Multiple Access with Collision Avoidance (CSMA/CA) with a random backoff time. The channel occupancy is sensed using Physical Carrier Sense (PCS), which is provided by PHY detection of the Preamble. The random backoff mechanism spreads the opportunity to retransmit over a contention access time period thereby reducing the probability of traffic collision. Each time a device wishes to transmit data frames, it waits for a random period. Following the random backoff time, PCS determines whether the channel is bus or idle. If the channel is found to be idle, the device transmits its data. If the channel is found to be busy, the device waits for another random period before trying to access the channel again.

Traditionally, the CSMA/CA mechanisms used in PLC are similar to those used in wireless channels. However, they do not take into account the PLC channel characteristics. The main difference has been the use of preamble carrier sensing in PLC instead of energy detection, which is used in wireless channels, to know whether the channel is busy or not. Preamble carrier detection is preferred in PLC channels because PLC channels are susceptible to impulse noises that occur for a small durations. The impulse noises would trigger an energy detection mechanism that the channel is busy when in reality the channel is idle from other transmissions.

Preamble detection refers to the method wherein a PLC node correlates incoming signal on PLC channel with a known set of symbols (preambles) and decided that the channel is busy only on positive correlation. Although, existing methods greatly reduce the possibility that the node will not falsely detect a channel to be busy due to impulse noises, current CSMA/CA methods suffer from the time required to perform successful preamble detection.

In CSMA/CA, nodes typically separate the transmission attempts by choosing a random number of slots for each node. The nodes then sense the channel to see if the channel is busy before the end of this duration, and the nodes transmit the frame if the channel was found to be idle during this period.

For example, in the CSMA/CA used in G3 PLC networks, each node performs a preamble detection to know whether the channel is busy and if the channel is busy, then the node:
1. stops the random backoff counter,
2. doubles the contention window (CW), and
3. reattempts for CSMA/CA at the end of the transmission.

Since, the backoff is always terminated in a channel busy condition, false detection would prove costly to the system performance. Hence, preamble detection is preferred over energy detection in PLC systems. However, for successful operation of CSMA/CA, a node must be able to detect whether the channel is busy within the duration of this slot which is commonly referred to as “unitBackOffDuration”.

However, in some standards, such as G3 and IEEE P1901.2, the preamble duration is much longer than the slot duration and due to channel conditions successful preamble detection may take up to longest preamble length leading to loss in system performance. This stems from the fact that adjacent nodes may not be able to detect a transmission within the slot duration.

A straight forward method to handle such scenario is to increase the slot duration to the longest preamble length. However, this would cause the system throughput to go down as it increases the net idle time.

### SUMMARY OF THE INVENTION

Embodiments of the invention include a method for performing CSMA/CA that takes into account the characteristics of power line communication (PLC) channels by combining energy detection and preamble detection to improve system performance without the increasing the slot duration.

The proposed CSMA/CA method is independent of the algorithm used to update the contention window (CW) on success/failure. Any such CW update algorithm can be supported in this CSMA/CA method.

A node needs to perform one of the following methods to support this CSMA/CA mechanism:
1. Run energy detection first and then use preamble detection only after the energy detection returns positive; or
2. Run both energy detection and preamble detection simultaneously.

In one embodiment, a system and method for performing Carrier Sense Multiple Access with Collision Avoidance (CSMA/CA) in a power line communication (PLC) network is disclosed. A PLC device having a data packet for transmission monitors energy on a PLC channel. The device performs a preamble detection operation and transmits the data packet if no energy is detected on the PLC channel. The device freezes a backoff counter at a current value when energy is detected on the PLC channel while performing the preamble detection operation. After the preamble detection timeout period, the device decrements the backoff counter. In one embodiment, the backoff counter is decremented by a value equal to the preamble detection timeout period divided by the slot duration.

If no preamble is detected, the device transmits the data packet on the PLC channel by the PLC device if a current contention window value is zero, or the device decrements the contention window value if a current contention window value greater than zero.

The preamble detection operation may be performed after energy is detected on the PLC channel or simultaneously with an energy detection operation.

In one embodiment, the PLC device includes a receiver configured to monitor energy on a PLC channel of the PLC network when a data packet is available for transmission. The receiver may be configured to perform a preamble detection operation on the PLC channel. The device also includes a transmitter configured to transmit the data packet on the PLC channel. The receiver performs the preamble detection operation either after energy is detected on the PLC channel or simultaneously with an energy detection operation.

The transmitter is configured to transmit the data packet without waiting for the receiver to complete the preamble detection operation when no energy is detected on the PLC channel. When has been energy detected on the PLC channel, the transmitter transmits the data packet after the receiver determines that no preamble is detected

The PLC device may include a processor configured to perform CSMA/CA operations. The processor freezes a backoff counter at a current value when energy is detected on the PLC channel by the receiver. The processor decrements the backoff counter after a preamble detection timeout period. The backoff counter may be decremented by a value equal to the preamble detection timeout period divided by the slot duration.

When no preamble is detected on the channel, the transmitter transmits the data packet on the PLC channel, if a current contention window value is zero, or continues to decrement the contention window value, if a current contention window value greater than zero.

In another embodiment, a method for performing CSMA/CA in a PLC network, comprises setting a contention window value for a PLC device having a data packet for transmission, and allowing a random backoff period to elapse, where the random backoff period selected based on the contention window value. The energy levels on a PLC channel are monitored after the random backoff period elapses. The backoff counter is frozen at a current value for a preamble detection timeout period when energy is detected on the PLC channel. The backoff decrementing process continues if no preamble is detected on the PLC channel.

The data packet is transmitted if no energy is detected on the PLC channel. Alternatively, the data packet is transmitted if no preamble is detected on the PLC channel and the contention window value is zero.

### BRIEF DESCRIPTION OF THE DRAWINGS

Having thus described the invention in general terms, reference will now be made to the accompanying drawings, wherein:

FIG. 1 is a diagram of a PLC system according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a schematic block diagram illustrating one embodiment of a system configured for point-to-point PLC.

FIG. 6 is a block diagram of an integrated circuit according to some embodiments.

FIG. 7 illustrates a representation of a PLC network according to one embodiment.

FIG. 8 is a flowchart illustrating a CSMA/CA mechanism that combines energy detection and preamble detection.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

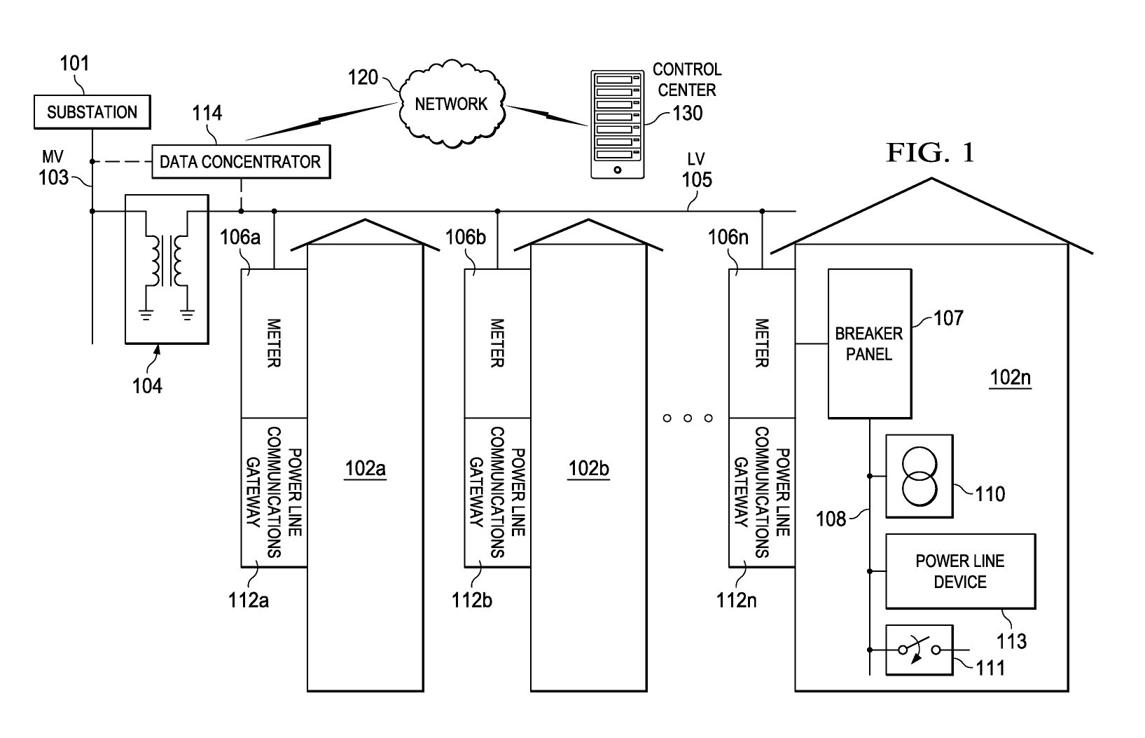

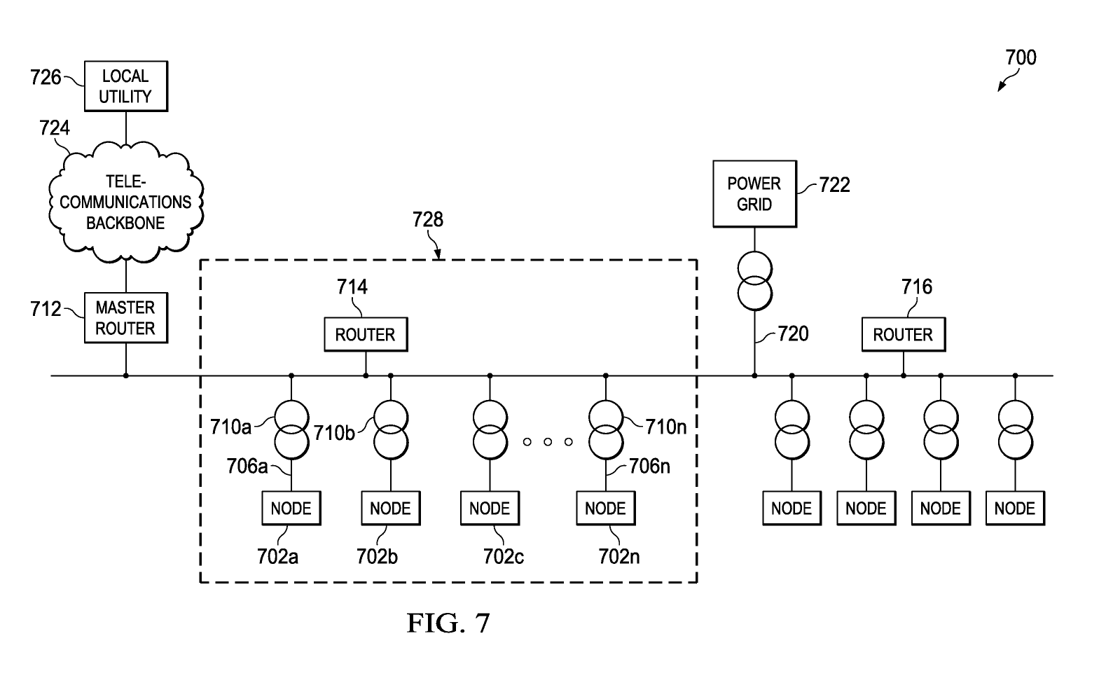

A coordinator or router in a PLC network transmits common frames, such beacon requests, beacons, and route request messages, using both differential modulation and coherent modulation. In one embodiment of the present invention, a router transmits sequential beacon frames using differential and coherent modulation on each tone mask. In another embodiment, the router transmits beacon frames using differential modulation on all of the tone masks and then transits another set of beacon frames using coherent modulation on each tone mask. An example of such a system is described below in FIGS. 7-10. FIGS. 1-6 describe the G3-PLC systems and methods generally.

FIG. 1 illustrates a power line communication system having overlapping priority contention windows in G3-PLC networks according to some embodiments. Medium voltage (MV) power lines 103 from subnode 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters or nodes 106a-nwhich are typically mounted on the outside of residences 102a-n. Although referred to as “residences,” premises 102a-n may include any type of building, facility, electric vehicle charging node, or other location where electric power is received and/or consumed. A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use a carrier signal having a frequency different from that of the power signal. The carrier signal may be modulated by the data, for example, using an OFDM technology or the like described, for example, G3-PL standard.

PLC modems or gateways 112a-n at residences 102a-n use the MV/LV power grid to carry data signals to and from PLC data concentrator or router 114 without requiring additional wiring. Data concentrator or router 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more PLC data concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

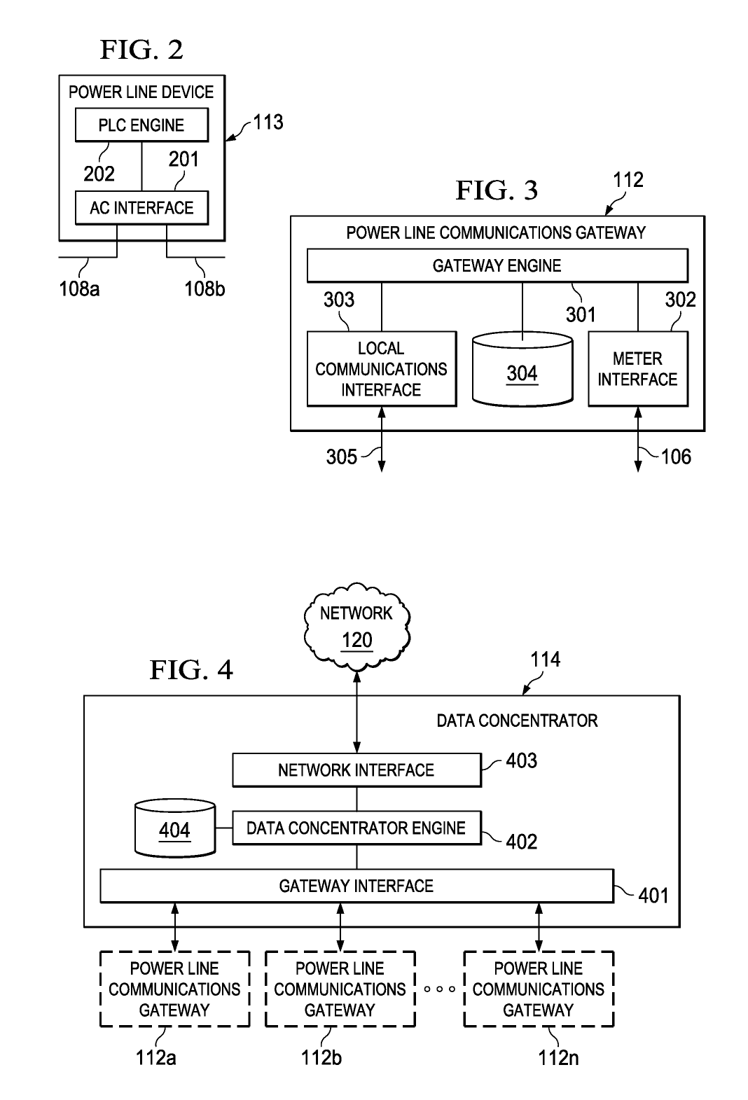

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZigBee, Bluetooth, Wi-Fi, Wi-Max, Ethernet, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 305 in assigning, allocating, or otherwise managing frequency bands assigned to its various PLC devices.

FIG. 4 is a block diagram of PLC data concentrator or router 114 according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

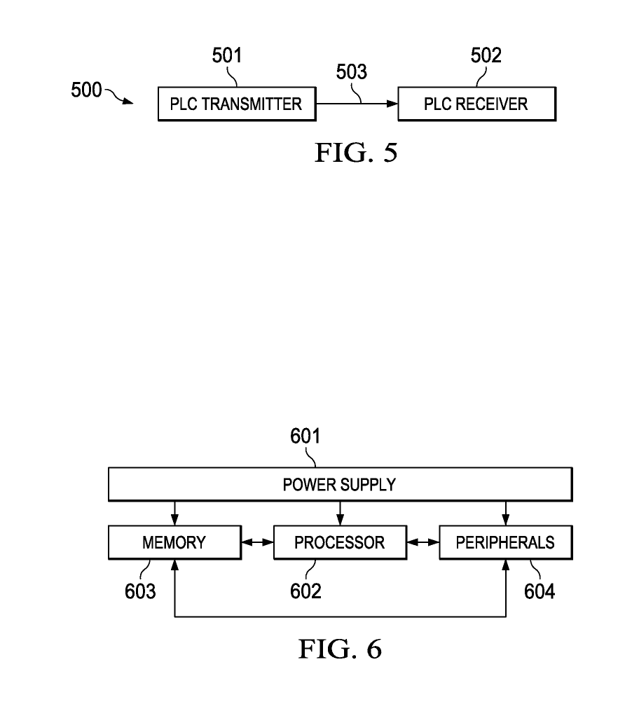

FIG. 5 is a schematic block diagram illustrating one embodiment of a system 500 configured for point-to-point PLC. The system 500 may include a PLC transmitter 501 and a PLC receiver 502. For example, a PLC gateway 112 may be configured as the PLC transmitter 501 and a PLC device 113 may be configured as the PLC receiver 502. Alternatively, the PLC device 113 may be configured as the PLC transmitter 501 and the PLC gateway 112 may be configured as the PLC receiver 502. In still a further embodiment, the data concentrator 114 may be configured as either the PLC transmitter 501 or the PLC receiver 502 and configured in combination with a PLC gateway 112 or a PLC device 113 in a point-to-point system 500. In still a further embodiment, a plurality of PLC devices 113 may be configured to communicate directly in a point-to-point PLC system 500 as described in FIG. 5. Additionally, the subnode 101 may be configured in a point-to-point system 500 as described above. On of ordinary skill in the art will recognize a variety of suitable configurations for the point-to-point PLC system 500 described in FIG. 5.

FIG. 6 is a block diagram of a circuit for implementing the transmission of multiple beacon frames using different modulation techniques on each tone mask in a PLC network according to some embodiments. In some cases, one or more of the devices and/or apparatuses shown in FIGS. 1-5 may be implemented as shown in FIG. 6. In some embodiments, processor 602 may be a digital signal processor (DSP), an application specific integrated circuit (ASIC), a system-on-chip (SoC) circuit, a field-programmable gate array (FPGA), a microprocessor, a microcontroller, or the like. Processor 602 is coupled to one or more peripherals 604 and external memory 603. In some cases, external memory 603 may be used to store and/or maintain databases 304 and/or 404 shown in FIGS. 3 and 4. Further, processor 602 may include a driver for communicating signals to external memory 603 and another driver for communicating signals to peripherals 604. Power supply 601 provides supply voltages to processor 602 as well as one or more supply voltages to memory 603 and/or peripherals 604. In some embodiments, more than one instance of processor 602 may be included (and more than one external memory 603 may be included as well).

Peripherals 604 may include any desired circuitry, depending on the type of PLC system. For example, in an embodiment, peripherals 604 may implement local communication interface 303 and include devices for various types of wireless communication, such as Wi-Fi, ZigBee, Bluetooth, cellular, global positioning system, etc. Peripherals 604 may also include additional storage, including RAM storage, solid-state storage, or disk storage. In some cases, peripherals 604 may include user interface devices such as a display screen, including touch display screens or multi-touch display screens, keyboard or other input devices, microphones, speakers, etc.

External memory 603 may include any type of memory. For example, external memory 603 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 603 may include one or more memory modules to which the memory devices are mounted, such as single inline memory modules (SIMMs), dual inline memory modules (DIMMs), etc.

FIG. 7 illustrates an example embodiment of a PLC network 700 for a local utility PLC communications system. Network 700 includes LV nodes 702a-n and each of the nodes 702a-n is connected to MV power line 720 through a corresponding transformer 710a-n and LV line 706a-n. Router, or modem, 714 is also connected to MV power line 720. A sub-network 728, or neighborhood 728, may be represented by the combination of nodes 702a-n and router 714. Master router 712 and router 716 are also connected to MV line 720, which is powered by power grid 722. Power grid 722 represents the high voltage power distribution system.

Master router 712 may be the gateway to telecommunications backbone 724 and local utility, or control center, 726. Master router 712 may transmit data collected by the routers to the local utility 726 and may also broadcast commands from local utility 726 to the rest of the network. The commands from local utility 726 may require data collection at prescribed times, changes to communication protocols, and other software or communication updates.

During UL communications, the nodes 702a-n in neighborhood 728 may transmit usage and load information (“data”) through their respective transformer 710a-n to the MV router 714. In turn, router 714 forwards this data to master router 712, which sends the data to the utility company 726 over the telecommunications backbone 724. During DL communications (router 714 to nodes 702a-n) requests for data uploading or commands to perform other tasks are transmitted.

In accordance with various embodiments, nodes 702a-n employ a CSMA/CA mechanism that combines energy detection and preamble detection to access the PLC network. The nodes may do either of the following CSMA/CA methods to access the channel: (1) run energy detection first and then use preamble detection only after energy detection returns positive, or (2) run both energy detection and preamble detection simultaneously. The CSMA-CA algorithm is used before the transmission of data or MAC command frames.

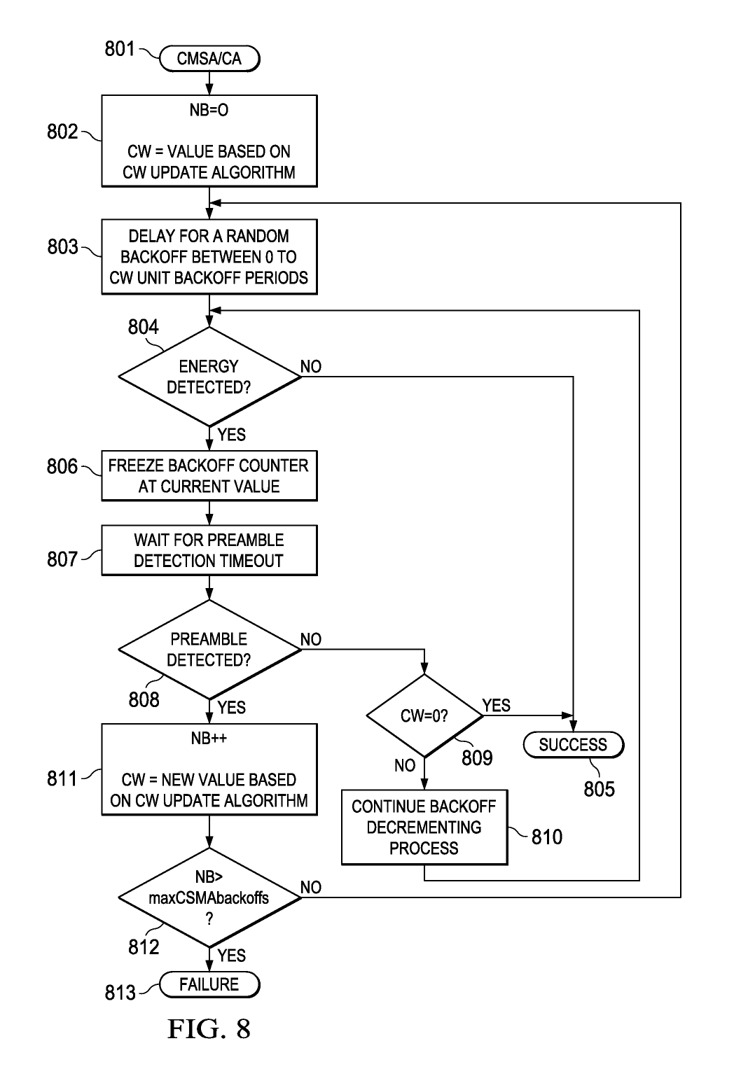

FIG. 8 is a flowchart illustrating a CSMA/CA mechanism that combines energy detection and preamble detection. The algorithm is implemented using units of time called unit backoff periods, where one backoff period is equal to a number of symbols (e.g., aUnitBackoffPeriod symbols in P1901.2).

A node begins the CSMA/CA method at 801. In step 802, the node sets values for variables NB (number of backoffs) and CW (contention window). NB is the number of times the CSMA-CA algorithm was required to backoff while attempting a current transmission. The value of NB is initialized to zero before each new transmission attempt. CW is the contention window for the node. The CWvalue may be set using any appropriate contention window update algorithm. In one embodiment, for example, for the first transmission, CW is initialized to 2^{MinBE}, where MinBE is a minimum backoff exponent value. For every channel access failure, the CW value is doubled. The maximum value of CW is bounded by 2^{MaxBE}, where MaxBE is a maximum backoff exponent value. Upon a successful transmission, the CW value may be adjusted.

After setting the NB and CW values in step 802, the node moves to step 803. The node waits for the correct contention window in step 802 by delaying for a random number of unit backoff periods selected between zero and CW.

After the delay 803, the node senses for energy on the channel in step 804. If no energy is detected, then the node has successfully accessed the channel and transmits its data packet in step 805.

If the node detects energy on the line in step 804, then the node will then wait for preamble detection to complete. This state will not be considered as a channel busy case and the CWvalue will not be updated. The node will freeze the backoff counter decrementing process at its current value in step 806. The energy detection in step 804 may be due to another node's transmission or may be a false detection due, for example, to noise on the line. Accordingly, the node will begin preamble detection when energy is detected and will wait in step 807 for the preamble detection process to timeout.

The node will wait for a time period called “Preamble Detection Timeout.” If no preamble is detected during this time, the node will continue to decrement the back off counter. In another embodiment, the node may decrement the backoff counter by a value equal to (Preamble Detection Timeout/Slot Duration) to account for the time lost while waiting for the preamble detection. If the new value is less than zero, the node will assume that the random back off has ended and it will transmit the frame. If the backoff counter has a non-zero value, then the node will resume the back off decrementing process.

The preamble detection time may set to be equal to the largest preamble duration or to a value that guarantees preamble detection under most channel conditions to get a good system performance.

In step 808, the node evaluates whether the preamble has been detected. If the preamble was not detected, then the node determines the current value of CW. If CW has reached zero in step 809, then the node has successfully accessed the channel and transmits its data packet in step 805. Otherwise, if CW is greater than zero, then the node continues the backoff counter decrementing process in step 810 before moving back to step 804.

If a preamble is detected at step 808 (i.e., the channel is busy), then in step 811 the node will increment NB and will set a new CW value using the appropriate CW update algorithm.

In step 812, the node determines if NB is greater than a maximum number of CSMA backoffs (maxCSMAbackoffs). If so, then the CSMA-CA algorithm terminates at step 813 with a channel access failure status. If NB is less than or equal to maxCSMbBackoffs, then the CSMA-CA algorithm returns to step 803.

The value of CW can be updated based on any algorithm. In one embodiment, CW is initialized to a minimum CW and then upon failure to access the channel, CW is doubled. The number of backoff attempts (maxCSMAbackoffs) may be set to one in some embodiments, and the CW is updated based on an earlier transmission attempt.

Because the slot duration has to take into account only the time required to perform energy detection, the slot duration can be kept small. In other embodiments, preamble detection may take a longer time when compared to slot duration without significantly increasing the collision probability. The proposed CSMA/CA mechanism helps improve system performance in PLC networks where the preamble duration is larger than the unit backoff period duration.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

What is claimed is:

1. A method for performing Carrier Sense Multiple Access with Collision Avoidance (CSMA/CA) in a power line communication (PLC) network, comprising:
monitoring energy on a PLC channel by a PLC device having a data packet for transmission;
performing a preamble detection operation; and
transmitting the data packet on the PLC channel by the PLC device if no energy is detected on the PLC channel.

2. The method of claim 1, further comprising:
freezing a backoff counter at a current value when energy is detected on the PLC channel.

3. The method of claim 2, further comprising:
after a preamble detection timeout period, decrementing the backoff counter.

4. The method of claim 3, wherein the backoff counter is decremented by a value equal to the preamble detection timeout period divided by a slot duration.

5. The method of claim 1, wherein if no preamble is detected, then further comprising:
transmitting the data packet on the PLC channel by the PLC device if a current contention window value is zero; and
decrementing the contention window value if a current contention window value greater than zero.

6. The method of claim 1, wherein the preamble detection operation is performed after energy is detected on the PLC channel.

7. The method of claim 1, wherein the preamble detection operation is performed simultaneously with an energy detection operation.

8. A device for performing Carrier Sense Multiple Access with Collision Avoidance (CSMA/CA) in a power line communication (PLC) network, comprising:
a receiver configured to monitor energy on a PLC channel of the PLC network when a data packet is available for transmission by the device, the receiver further configured to perform a preamble detection operation on the PLC channel; and
a transmitter configured to transmit the data packet on the PLC channel.

9. The device of claim 8, the transmitter further configured to transmit the data packet without waiting for the receiver to complete the preamble detection operation when no energy is detected on the PLC channel.

10. The device of claim 8, the transmitter further configured to transmit the data packet after the receiver determines that no preamble is detected when has been energy detected on the PLC channel.

11. The device of claim 8, further comprising:
a processor configured to perform CSMA/CA operations, the processor freezing a backoff counter at a current value when energy is detected on the PLC channel by the receiver.

12. The device of claim 11, further comprising:
the processor configured to decrement the backoff counter after a preamble detection timeout period.

13. The device of claim 12, wherein the backoff counter is decremented by a value equal to the preamble detection timeout period divided by a slot duration.

14. The device of claim 8, wherein if no preamble is detected, the transmitter configured to transmit the data packet on the PLC channel if a current contention window value is zero and to decrement the contention window value if a current contention window value greater than zero.

15. The device of claim 8, wherein the preamble detection operation is performed after energy is detected on the PLC channel.

16. The device of claim 1, wherein the preamble detection operation is performed simultaneously with an energy detection operation.

17. A method for performing Carrier Sense Multiple Access with Collision Avoidance (CSMA/CA) in a power line communication (PLC) network, comprising:
setting a contention window value for a PLC device having a data packet for transmission;
allowing a random backoff period to elapse, random backoff period selected based on the contention window value;
monitoring energy levels on a PLC channel after the random backoff period elapses;
freezing a backoff counter at a current value for a preamble detection timeout period when energy is detected on the PLC channel; and
continuing a backoff decrementing process if no preamble is detected on the PLC channel.

18. The method of claim 17, further comprising:
transmitting the data packet if no energy is detected on the PLC channel.

19. The method of claim 17, further comprising:
transmitting the data packet if no preamble is detected on the PLC channel and if the contention window value is zero.

20. The method of claim 17, wherein the energy levels are monitored simultaneously with a preamble detection operation.
